(19) United States
(12) Patent Application Publication
(10) Pub. No.: US 2014/0100982 A1
(43) Pub. Date: Apr. 10, 2014

(54) GUIDED PROCUREMENT SYSTEM AND METHOD

(71) Applicants: SACHIN SHARMA, MUMBAI (IN); PRASAD GUPTE, MUMBAI (IN)

(72) Inventors: SACHIN SHARMA, MUMBAI (IN); PRASAD GUPTE, MUMBAI (IN)

(21) Appl. No.: 13/739,977

(22) Filed: Jan. 11, 2013

(30) Foreign Application Priority Data
Oct. 5, 2012 (IN) 2923/MUM/2012

(51) Int. Cl. G06Q 30/06

(52) U.S. Cl. CPC G06Q 30/0605
USPC 705/26.2

(57) ABSTRACT

A guided procurement system for guiding the buyer for procuring when the item to be purchased is not present in the catalog database, which is an integration of a procurement tool, supplier information system tool and supplier performance system tool. The system includes a processor unit and a computer readable medium storing instructions executable by the processor unit, including a first procurement guiding module that is adapted for guiding the requester for procurement when the item is not available in the catalog database, and a second procurement guiding module that is adapted for guiding the procurement team or the buyer for procurement from the right supplier. The system is adapted for guiding the buyer while procuring by suggesting the source of procurement based on the user provided information on a web form. It further guides by suggesting the supplier from which a particular item can be procured.

### CROSS-REFERENCE TO RELATED APPLICATION

The instant application claims priority to Indian Patent Application Serial No. 2923/MUM/2012, filed Oct. 5, 2012, pending, the entire specification of which is expressly incorporated herein by reference.

### FIELD OF THE INVENTION

The present invention generally to electronic procurement, and more particularly, to a system and method for guiding the buyer for procurement, for example, when the item is not present in the catalog database.

### BACKGROUND OF THE INVENTION

In the electronic procurement context, it is a routine practice of searching for an item in a catalog (e.g., an online catalog) while attempting to procure various items; however, there is no system that can provide information for an item that is not present in the catalog.

Accordingly, there exists a need for new and improved electronic procurement systems and methods for providing information for items that are not present in the catalog that overcome at least one of the aforementioned problems.

### SUMMARY OF THE INVENTION

In accordance with the general teachings of the present invention, a system and a method is provided for guiding the buyer during a procurement process, for example an electronic procurement process, when the item is not present in the catalog, for example, an online catalog database.

More specifically, the system and method is adapted for guiding the buyer while procuring, for example, by suggesting the source of procurement based on the user provided information on a web-based form. Additionally, the system and method is also adapted for guiding the buyer while procuring by suggesting the supplier from which a particular item can be procured.

In accordance with one embodiment of the present invention, there is provided a guided procurement system for guiding the buyer for procuring when the item to be purchased is not present in the catalog database. In accordance with one aspect of this embodiment, the system includes an integration of a procurement tool, a supplier information system tool, and a supplier performance system tool.

In accordance with another embodiment of the present invention, the system includes:

a processor unit; and

a computer readable medium storing instructions executable by the processor unit, including:

a first procurement guiding module that is adapted for guiding the requester for procurement when the item is not available in the catalog database; and

a second procurement guiding module that is adapted for guiding the procurement team or the buyer for procurement from the right supplier.

By way of a non-limiting example, the system and method of the present invention guides the buyer during the procurement process by suggesting the source of procurement based on the user provided information on a web-based form. By way of a non-limiting example, the system and method of the present invention further guides the buyer during the procurement process by suggesting the supplier from which a particular item can be procured.

An object of the present invention is to provide a system and method for guiding the buyer during the procurement process, for example, when the item is not present in the catalog database.

Another object of the present invention is to provide a system and method for guiding the buyer during the procurement process by suggesting the source of procurement based on the user provided information on web-based form.

Yet another object of the present invention is to provide a system and method for guiding the buyer during the procurement process by suggesting the supplier from which a particular item can be procured.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will now be described in relation to the accompanying drawings in which:

FIG. 1 illustrates a schematic of the work flow of a guided procurement system;

FIG. 2 illustrates a schematic of a web-based form generation of the guided procurement system; and

FIG. 3 illustrates a schematic of the suggestion creation system of a source of procurement and supplier of the item by the guided procurement system.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

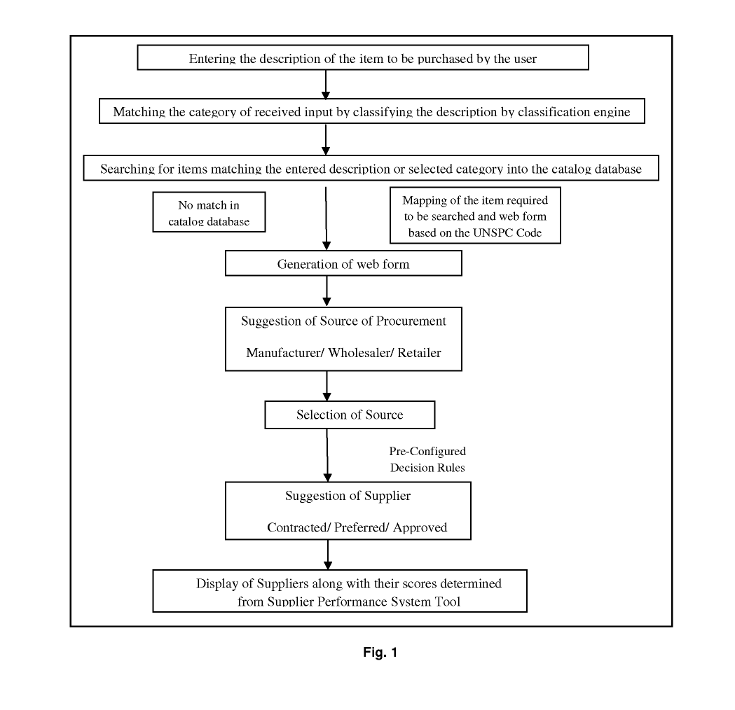

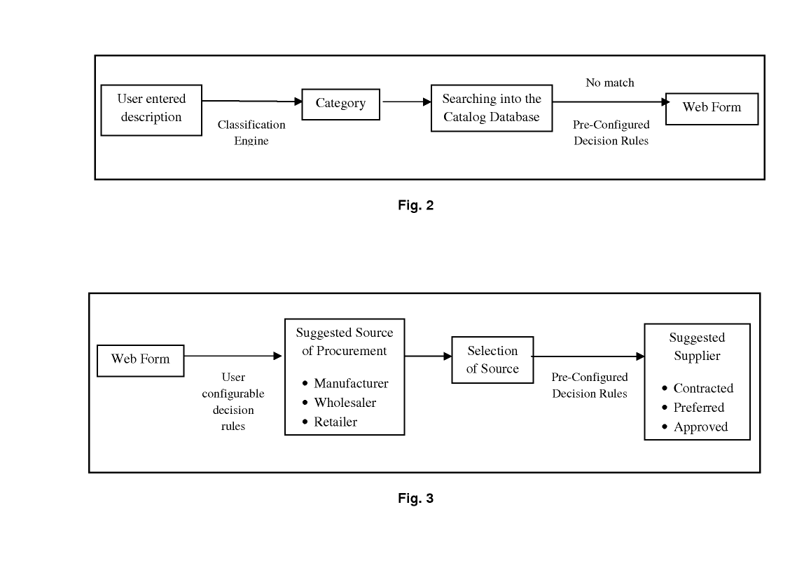

Referring to FIGS. 1-3, and according to an exemplary embodiment, a guided procurement system may include an integration of a procurement tool, a supplier information system tool, and a supplier performance system tool. The system may include a processor unit, and a computer readable medium storing instructions executable by the processor unit, including a first procurement guiding module, and a second procurement guiding module.

According to another exemplary embodiment, the first procurement guiding module of the guided procurement system may be adapted for guiding the requester during the procurement process, for example, when the item is not available in the catalog database, for example, the online catalog database.

By way of a non-limiting example, the first procurement guiding module may include an input system to enter the description of the item to be purchased by the user, a matching system to match the category of received input by classifying the description by classification engine, a searching system to search for items matching the entered description or selected category into the catalog database of the procurement tool, and/or a first guiding system to guide the user when no items are found in catalog database by providing a guiding link or button and then generating a web-based form based at least upon one or more pre-configured decision rule(s).

The decision rule of the first guiding system may include mapping of the item required to be searched and a web-based form based on the United Nations Standard Products and Services Code (“UNSPC”) Code.

According to yet another exemplary embodiment, the first procurement guiding module may further include a suggesting system that may be adapted for suggesting the source of procurement based on the user provided information key fields on the web-based form. This suggestion of the source of procurement by the suggesting system may be done by mapping the source based upon the user configurable decision rule(s), wherein the suggested source may be manufacturer, wholesaler, and/or retailer. The suggesting system may be further adapted for suggesting the supplier(s) from which the particular item can be procured upon selection of the source of procurement by user, for example, based at least upon one or more pre-configured rule(s), wherein the supplier suggestions may be contracted suppliers, preferred suppliers, and/or approved suppliers for the corresponding category of the item from the supplier information system tool. These pre-configured rule(s) may include, without limitation, mapping of the UNSPC Category Code of the item with the suppliers, corresponding to that category code present in the supplier information system tool. Another pre-configured rule(s) may include, without limitation, historic transactions with the supplier of the particular item to be purchased.

According to still another exemplary embodiment, the second procurement guiding module may be adapted for guiding the procurement team or the buyer for procurement from the right supplier, wherein the second procurement guiding module includes a second guiding system to provide information on the availability of contracted supplier(s) for the particular item to be purchased. The second guiding system may further provide information on approved supplier(s) for the particular item to be purchased, a ranking system to rank the suppliers based on their score determined from the supplier performance report which may be present in the supplier performance system tool, and/or a display system to display the suppliers with their performance scores.

By way of a non-limiting, the guided procurement system facilitates the user to suggest new vendors.

### EXAMPLE

The user will enter a free-text description of the item to be procured in the common natural language that includes quantity, color, size, price, part number, etc. Based on this description, the classification engine will classify into UNSPC code and web-based form for the corresponding category of UNSPC code is displayed to user. Based on the user entered information of key fields on web form, a source of procurement will be suggested. If the user wants to buy pens, then based on the quantity of pens, the suggesting system will suggest whether he or she should buy from the manufacturer, retailer or wholesaler. Once the source is selected by the user, the suggesting system will further suggest suppliers for it. This suggestion will be based on mapping of the UNSPC code of the item with the suppliers corresponding to that category code present in the supplier information system tool and historic transactions with the supplier of that item. These suppliers will be displayed along with their scores determined from the supplier performance report present in the supplier performance system tool.

The guided procurement system of the present invention has following advantages: (1) it helps capture all relevant information pertaining to what the user needs, which avoids repeated back-and-forth with the procurement team, which is mostly offline; (2) correct classification of the requirement of the system ensures machine-based purchasing compliance by enforcing purchasing policies, budgets and approval workflows; (3) it drives maximum spend through preferred/contracted suppliers; and/or (4) it also facilitates the user to suggest new vendors.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A guided procurement system, the system including an integration of a procurement tool, a supplier information system tool, and a supplier performance system tool, the system comprising:
a processor unit; and
a computer readable medium storing instructions executable by the processor unit, comprising:
a first procurement guiding module; and
a second procurement guiding module.

2. The system as claimed in claim 1 wherein, the first procurement guiding module is adapted for guiding a requester during a procurement process when the item is not available in a catalog database, the module comprising:
an input system to enter the description of the item to be purchased by the user;
a matching system to match the category of received input by classifying the description by a classification engine;
a searching system to search for items matching the entered description or selected category into the catalog database of the procurement tool;
a first guiding system to guide the user when no items are found in catalog database by providing a guiding link or button and then generating a web-based form based at least upon one or more pre-configured decision rules.

3. The system as claimed in claim 2, wherein the decision rule includes mapping of the item required to be searched and the web-based form based on the UNSPC Code.

4. The system as claimed in claim 1, wherein the first procurement guiding module is further adapted for filling the information of key fields on a web-based form.

5. The system as claimed in claim 1, wherein the first procurement guiding module further comprises a suggesting system that is adapted for suggesting the source of procurement based on the user provided information of a web-based form.

6. The system as claimed in claim 5, wherein the suggesting system suggests the source of procurement by mapping the source based upon user configurable decision rules, wherein the suggested source includes manufacturer, wholesaler, and/or retailer.

7. The system as claimed in claim 5, wherein the suggesting system is further adapted for suggesting the suppliers from which the particular item can be procured upon selection of the source of procurement by the user, based at least upon one or more pre-configured rules.

8. The system as claimed in claim 7, wherein the pre-configured rules include mapping of UNSPC Category Code of the item with the suppliers corresponding to that category code present in the supplier information system tool.

9. The system as claimed in claim 7, wherein another pre-configured rule includes historic transactions with the supplier of the particular item to be purchased.

10. The system as claimed in claim 7, wherein supplier suggestions by the suggesting system includes contracted suppliers, preferred suppliers, and/or approved suppliers for the corresponding category of the item from the supplier information system tool.

11. The system as claimed in claim 1, wherein the second procurement guiding module is adapted for guiding the procurement team or the buyer for procurement from the right supplier, the second procurement guiding module comprising:
a second guiding system to provide information on the availability of contracted suppliers for the particular item to be purchased, wherein the second guiding system further provides information of approved suppliers for the particular item to be purchased;
a ranking system to rank the suppliers based on their score determined from a supplier performance report that is present in the supplier performance system tool; and
a display system to display suppliers with their performance scores.

12. The system as claimed in claim 1, wherein the guided procurement system facilitates the user to suggest new vendors.

13. A method for guiding procurement, the method comprising:
providing a first procurement guiding module that is adapted for guiding the requester during the procurement process when the item is not available in a catalog database; and
providing a second procurement guiding module that is adapted for guiding the procurement team or the buyer for procurement from the right supplier.

14. The method as claimed in claim 13, wherein the first procurement guiding module comprises:
entering the description of the item to be purchased by the user;
matching the category of received input by classifying the description by classification engine;
searching for items matching the entered description or selected category into the catalog database of procurement tool;
guiding the user when no items are found in catalog database by providing guiding link or button and then generating a web-based form based at least upon one or more pre-configured decision rules.

15. The method as claimed in claim 14, wherein the decision rule includes mapping of the item required to be searched and the web-based form based on the UNSPC Code.

16. The method as claimed in claim 13, wherein the first procurement guiding module is further adapted for filling the information of key fields of the web-based form.

17. The method as claimed in claim 13, wherein the first procurement guiding module further comprises suggesting the source of procurement based on the user provided information on the web-based form.

18. The method as claimed in claim 17, wherein the source of procurement is suggested by mapping the source based upon user configurable decision rules, wherein the suggested source includes manufacturer, wholesaler, and/or retailer.

19. The method as claimed in claim 17, wherein the suggesting step is further adapted for suggesting the suppliers from which the particular item can be procured upon selection of source of procurement by user, based at least upon one or more pre-configured rules.

20. The method as claimed in claim 19, wherein the pre-configured rule includes mapping of UNSPC Category Code of the item with the suppliers corresponding to that category code present in the supplier information system tool.

21. The method as claimed in claim 19, wherein another pre-configured rule includes historic transactions with the supplier of the particular item to be purchased.

22. The method as claimed in claim 19, wherein the supplier suggestions include contracted suppliers, preferred suppliers, and/or approved suppliers for the corresponding category of the item from the supplier information system tool.

23. The method as claimed in claim 13, wherein the second procurement guiding module comprises:
providing a guiding system to provide information of the availability of contracted suppliers for the particular item to be purchased, wherein the guiding system further provides information of approved suppliers for the particular item to be purchased;
ranking the suppliers based on their score determined from the supplier performance report which is present in the supplier performance system tool; and
displaying suppliers with their performance scores.
